(19) United States
(12) Patent Application Publication
(10) Pub. No.: US 2022/0072621 A1
(43) Pub. Date: Mar. 10, 2022

(54) BUILD MATERIAL SEPARATION

(71) Applicant: HEWLETT-PACKARD DEVELOPMENT COMPANY, L.P., Spring, TX (US)

(72) Inventors: Pablo Antonio MURCIEGO RODRIGUEZ, Barcelona (ES); David CHANCLON FERNANDEZ, Barcelona (ES); Jorge DIOSDADO BORREGO, Barcelona (ES)

(21) Appl. No.: 17/418,627

(22) PCT Filed: Jul. 9, 2019
(86) PCT No.: PCT/US2019/041065

§ 371 Date: Jun. 25, 2021

(51) Int. Cl. B22F 12/88; B22F 10/68; B22F 10/66; B22F 10/85; B33Y 40/20; B33Y 50/02

(52) U.S. Cl. CPC B22F 12/88; B22F 10/68; B22F 10/66; B33Y 30/00; B33Y 40/20; B33Y 50/02; B22F 10/85

(57) ABSTRACT

An apparatus comprises a controller to cause an additive manufacturing system to perform a method, the method comprising:
controlling the additive manufacturing system to provide a plurality of articles in a multi-layer build arrangement in a build chamber, the multi-layer build arrangement comprising a plurality of article layers, each article layer comprising an article;
ejecting a portion of the multi-layer build arrangement from the build chamber; and
determining when a divider can be used to divide a first volume of build material of the multi-layer build arrangement from a remaining volume of build material of the multi-layer build arrangement, wherein the first volume comprises an article layer.

### BACKGROUND

Additive manufacturing systems can be used to manufacture three-dimensional (3D) objects. Some additive manufacturing machines are commonly referred to as “3D printers”. 3D printing can be achieved, for example, by forming successive layers of a build material in a build chamber and selectively solidifying portions of those layers to build up a 3D object. The build chamber may comprise several 3D objects which, after manufacture is completed, are surrounded by non-solidified build material or build cake. The build cake can be at least partially removed using post-processing techniques, which include decaking.

### BRIEF DESCRIPTION OF THE DRAWINGS

Some non-limiting examples of the present disclosure will be described in the following with reference to the appended drawings in which:

FIG. 1 shows a simplified example additive manufacturing post-processing system.

FIG. 2 shows a simplified view of an example of a method of operating an additive manufacturing system.

FIG. 3 shows a flow chart of example of a method of operating an additive manufacturing system.

FIG. 4 shows a flow chart of an example of a method of operating an additive manufacturing system.

### DETAILED DESCRIPTION

In the following detailed description, reference is made to the accompanying drawings which form a part hereof, and in which is shown by way of illustration of specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In some additive manufacturing processes, a binding agent is used to bind together metal particles of a powdered build material to form a solid object. The printing begins with a process of spreading the powdered build material (metal powder) on to the surface of a print area. A metal powder bed is thereby provided which covers a printing zone. Binding agent is then jetted at precise locations on to the powder bed to define the geometry of the single or multiple parts to be printed. The process then continues with an energy source assisting with the evaporation of liquid components. This process is repeated until the part or parts are formed layer by layer.

Build material may comprise any suitable form of build material, for example fibres, granules or powders. The build material can include thermoplastic materials, ceramic material and metallic materials. Non-solidified build material or cake is material such as powder which remains surrounding, and on the surfaces of, the parts or articles after manufacture. This can be removed in a process known as decaking. Once articles have been decaked, they may be removed and may be finished, and the remaining powder may be processed and reused. Finishing may comprise, for example, sintering, where the build material is a metal powder. Where the build material is a plastic powder, finishing may comprise, for example, bead-blasting, dying, polishing, or the like.

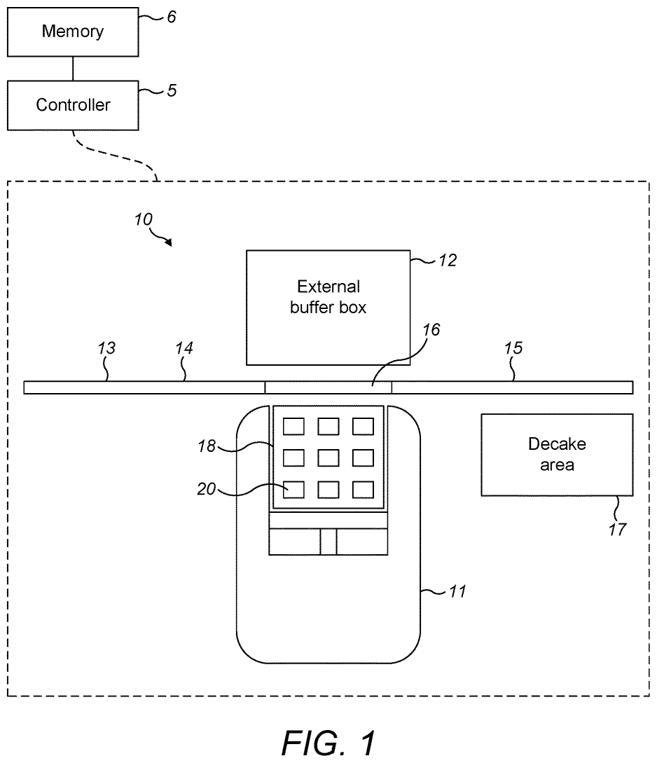

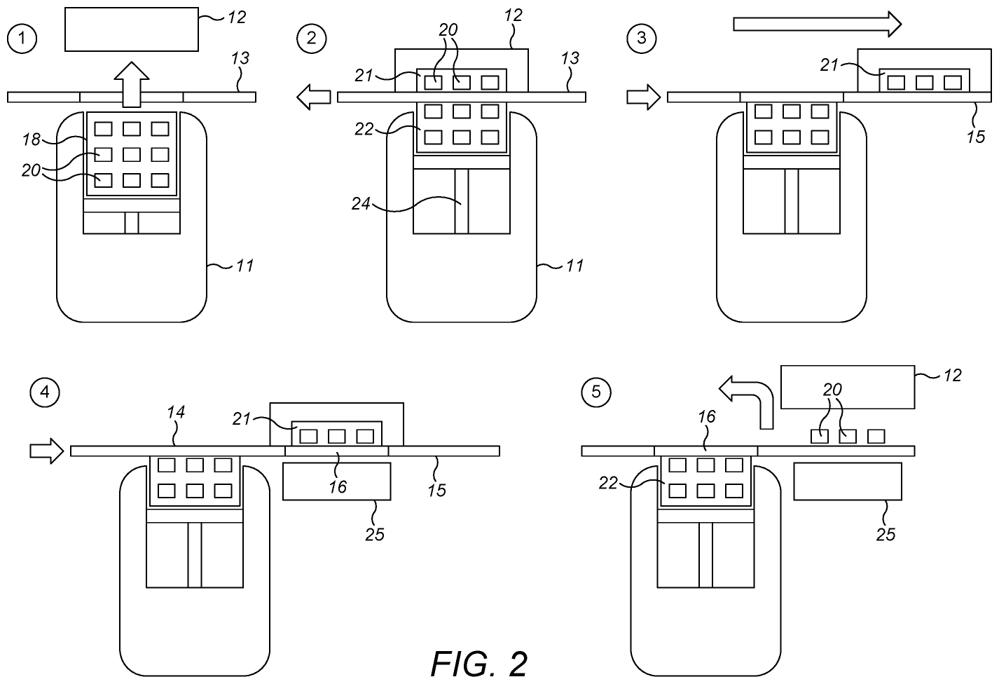

With reference to FIGS. 1 and 2, articles (20) may be manufactured or printed from build material (18) in a build chamber (11) in a multi-layer build arrangement in which multiple articles (20, see FIG. 2) are arranged at multiple vertical positions within the build chamber (11).

In an example, an apparatus comprises a controller (5) to cause an additive manufacturing system (10) to perform a method, the method comprising controlling the additive manufacturing system (10) to provide a plurality of articles in a multi-layer build arrangement in a build chamber (11), the multi-layer build arrangement comprising a plurality of article layers, each article layer (21) comprising an article (20); ejecting a portion of the multi-layer build arrangement from the build chamber (11); and determining when a divider (13), for example a guillotine, can be used to divide a first volume (21) of build material (18) of the multi-layer build arrangement from a remaining volume (22) of build material (18) of the multi-layer build arrangement, wherein the first volume (21) comprises an article layer (21). The remaining volume (22) may also comprise an article layer (21). The divider (13) functions to divide or separate the build material (18) and any suitable divider may be used, provided it may be inserted into the build material to divide it. For example, the divider may be a guillotine (13).

In another example, a method comprises providing a build chamber (11) of an additive manufacturing system (10) comprising a plurality of articles (20) manufactured by the additive manufacturing system in a multi-layer build arrangement comprising a plurality of article layers, each article layer (21) comprising an article (20); ejecting a portion of the multi-layer build arrangement from the build chamber (11); and determining when a divider (13), for example a guillotine, can be used to divide a first volume (21) of build material (18) of the multi-layer build arrangement from a remaining volume (22) of build material (18) of the multi-layer build arrangement, wherein the first volume (21) comprises an article layer (21). The remaining volume (22) may also comprise an article layer (21). Ejecting a portion of the multi-layer build arrangement from the build chamber (11) may be done automatically.

Determining when a divider (13) can be used to divide a first volume (21) of build material (18) of the multi-layer build arrangement may also be done automatically. The divider (13) functions to divide or separate the build material (18) and any suitable divider may be used, provided it may be inserted into the build material to divide it. For example, the divider may be a guillotine (13).

The build chamber (11) may for example be from a 3D printing system comprising multiple articles which have been printed. The method may be used to remove a first volume (21) of build material (18) which, for example, may comprise a number of articles (20). The first volume (21) may comprise one or a number of article layers: in the case where the first volume (21) comprises only one article layer (21), the first volume (21) and the article layer (21) may be identical. An article layer (21), as defined herein, is a layer comprising only one article (20) with respect to the vertical dimension, but may comprise one or a number of articles (20) with respect to the horizontal dimension. An article layer (21), as defined herein, should be distinguished from the about 50 to 100 micron thick individual layers of build material which are laid down in the process of manufacturing an article (20). The first volume (21) may comprise only one article layer (21) (that is, only one article (20) high with respect to the vertical dimension) because this may help prevent damage to an article (20) during post-processing procedures such as decaking, and also enables the decaking process to be more easily automated for certain kinds of article, such as metallic articles or delicate articles. Metallic articles are fragile at this stage because they are only loosely bound by a cured binding agent. To become fully dense metal objects they need removing, cleaning, and then sintering.

The remaining volume (22) of build material (18) may comprise only one article layer (21), or may comprise several article layers. It can improve efficiency for the remaining volume (22) to comprise several article layers. With this arrangement, the method may be repeated a number of times in order to remove and post-process (for example, decake) several article layers one after the other—all from a single build chamber (11), and thus from a single manufacturing or print cycle. Several article layers may be processed in a continuous operation. This reduces processing time, including reducing multiple idle times, and avoids the need for frequent re-cleaning and re-printing to the build chamber (11). This is seen for example with the manufacture or printing of only one article layer (21) at a time (for example with metallic or delicate articles), when the article layer (21) may be decaked, and then the manufacturing or printing repeated before further decaking can be done. Unnecessary multiple printing operations can thus be avoided or reduced.

In an example, the method may comprise forming a plurality of articles (20) in a multi-layer build arrangement comprising a plurality of article layers, each article layer (21) comprising an article (20); and inserting a divider, for example a guillotine, to automatically remove an article layer (21) from the multi-layer build, for post-processing. The article (20) may be a 3D printed article (20).

FIGS. 1 and 2 show an example of a multi-layer build arrangement comprising three article layers, each article layer (21) comprising a set of three articles (20) in the horizontal plane. The articles (20) in a given article layer (21) may be of identical, similar or different dimensions. A multi-layer build arrangement may comprise a plurality of article layers, and these may each be of similar or different dimensions. For example, a first article layer (21) may be about 100 mm thick (i.e. in the vertical dimension) and a second layer may for example be about 150 mm thick, or some other thickness. This may for example depend upon the size of the articles (20) in each article layer (21), and may be determined accordingly before or during printing. An article layer (21) may comprise an article (20) and a certain quantity of non-solidified build material (18) surrounding the article (20). For example, each article layer (21) may comprise a layer of about 3-5 mm thickness of non-solidified build material (18) below (and where applicable, above) the article (20). Non-solidified or unused build material is build material that is not used to form a 3D printed object. The dimensions of the article layer (21) may be selected or pre-determined, and as indicated may include a quantity of non-solidified build material (18) above and below each article (20) in the layer, such that the cutting and removal of the layer by, for example, a guillotine (13), does not cause any damage to an article (20). The non-solidified build material (18) may be removed in a subsequent decaking process. The decaking process may be performed automatically, or semi-automatically. Automatic decaking may comprise any suitable mechanism for removing non-solidified build material, provided it may be automatically controlled. For example, automatic decaking may comprise use of laminar or turbulent flow, for example of air, or may comprise vibration, or both; or any suitable mechanism.

During operation, the build chamber (11) may be automatically controlled, for example by a suitable controller (5), to eject a portion of the multi-layer build arrangement from the build chamber (11). An example of this is illustrated in FIG. 2, diagram 2. This may be done, for example, by use of a suitable ejection apparatus (24) which can function to eject or present a portion of the build material (18) from the build chamber (11). For example, the ejection apparatus (24) may be a hydraulically operated platform, or similar arrangement, which may be raised or lowered within the build chamber (11).

A controller (5) may for example control the build chamber (11) to present a first volume (21) of build material (18) from the multi-layer build arrangement (18). The controller (5) may for example automatically indicate to the build chamber (11) when it may eject a portion of the multi-layer build arrangement from the build chamber (11)—this indication may for example be based upon data indicating when a container (12) is correctly positioned. An example of this is illustrated in FIG. 2, diagrams 1 and 2. The controller (5) may also use data which serves to indicate what height of the first volume (21) of build material (18) the build chamber (11) may present, or use data which indicates the position of each article layer (21) within the build chamber (11). This data may for example be based upon the configuration of articles (20) within the build material, and may depend upon the vertical size or dimension of an article (20) within an article layer (21). Suitable ejection apparatus (24) may read the above data to determine how far to eject the build material so that a divider, for example a guillotine (13) may be inserted at a fixed point such that it will not damage any articles. Suitable ejection apparatus (24) may function to eject or present the first volume (21) (or a subsequent volume) of the build material (18) from the build chamber (11). For example, the ejection apparatus (24) may be a hydraulically operated platform (24) which may be raised or lowered within the build chamber (11). The first volume (21) of build material (18) may comprise only one article layer (21) or may comprise more than one article layer (21).

The portion or first volume of build material (18) may be received in a suitable container (12). For example, in operation, a suitable container (12) may be placed on top of the build chamber (11). The container (12) may be correctly aligned with the build platform, and may be secured, for example fastened, in position, as illustrated for example in FIG. 2, diagram 2. The container (12) may for example be latched to the build platform. The build platform may be raised, for example with ejection apparatus (24) described above, to push a portion of the contents of the build chamber (11), for example a first volume (21), into the container (12). A divider, for example a guillotine (13), may then be inserted to separate the ejected build material from the contents of the build chamber (11). The contents of the build chamber (11) may for example comprise the remaining volume (22) of build material (18). The guillotine (13) may be controlled to remove the ejected portion of build material (18), or first volume (21), from the remaining volume (22) of build material (18). The portion or first volume may comprise only one article layer (21)—as illustrated for example in FIG. 2, diagram 2. These operations may for example be controlled by a suitable controller (5).

In operation, a divider, for example a guillotine (13) or equivalent apparatus may be employed to perform more than one function, including to cut, hold, transfer and release a portion of build material. A guillotine (13) may for example be used to divide or separate a first volume (21) of build material (18) of the multi-layer build arrangement from the remaining volume (22) of the build material (18) of the multi-layer build arrangement. Such a first volume (21) may comprise only one article layer (21) or may comprise a plurality of article layers. The first volume (21) may in an example comprise only one article layer (21) comprising articles (20) which are delicate or which comprise a metallic material, although any suitable material may be used to print the articles.

The remaining volume (22) of build material (18) may reside in the build chamber (11) until it is desired to remove a further volume of build material. The process may be automated such that one volume of build material (18) after another may be removed in a continuous operation. For example, one article layer (21) after another article layer (21) and so on may be removed in a continuous operation. This process may continue until substantially all the build material (18) has been removed, or may be paused or stopped at any desired point.

This provides an efficient, faster process in which multiple articles (20) may be manufactured or printed at multiple vertical positions within a single build chamber (11) and the articles (20) then removed in batches. It enables the ability to remove one article layer (21) at a time, which layer may then be decaked, to be combined with multi-layer article build manufacture or printing. The process may, for example, be used for fragile articles (20) or parts, such as those comprising metallic materials or those comprising delicate structures, because such parts may be decaked from only one article layer (21), in order to prevent articles (20) from upper layers from falling and damaging the articles (20) underneath during the decaking process. Alternatively, a plurality of article layers may be separated and removed together, if desired.

The divider, for example a guillotine (13), may for example be automatically inserted into the build material (18) to separate a first volume (21) of build material (18) from the remaining volume (22) of build material. For example, the timing of this insertion may be determined and triggered when a suitable portion of build material (18) has been ejected from the build chamber (11) and, for example, received into a suitable container (12) positioned above the build chamber (11). A guillotine (13) may be used to divide or separate at least one article layer (21) from another article layer (21), for example to divide or separate only one article layer from at least one other article layer. For example, only one article layer (21) may be separated from a plurality of article layers, or a plurality of article layers may be divided or separated from another plurality of article layers. The guillotine (13) may be inserted between article layers into the non-solidified build material once a desired quantity of build material has been ejected, without damaging the manufactured or printed articles (20). The quantity, for example the height, of the build material ejected may vary. This may, for example, be determined by the configuration of the articles (20), and thus the height of the article layers, within the multi-layer build arrangement. The divider or guillotine (13) may be inserted into the build material at a set location relative to the top of the build chamber, and the point in the build material at which the guillotine may be inserted may thus be determined by the amount of build material that is ejected.

To effect insertion of the divider, for example a guillotine (13), into the build material, a tensile force, as opposed to a compressive force, may be applied to the guillotine (13). This may help when cutting certain build material, for example metal powder material or “cake”, as it may help prevent undesirable bending or distortion of the guillotine.

The build material (18) may comprise any suitable form of build material, for example fibres, granules or powders. The method may be used widely for additive manufacturing in any suitable material, for example in powder form. The build material (18) may include plastic, including thermoplastic, materials, ceramic material and metallic materials. Fragile articles, such as those comprising metallic materials, or delicate articles may be post-processed, for example decaked, more rapidly using the method.

After separation by the divider, for example a guillotine (13), the first volume (21) of build material (18) may for example be supported and held by the guillotine (13), which may act as a base, and a container, as shown for example in FIG. 2, diagram 2. In an example, a container (12) is employed to hold the first volume (21) of build material (18) to provide stability and to facilitate insertion of the guillotine (13). The first volume (21) may for example be transferred to a decaking area (17, 25) and the guillotine (13) moved such that an aperture (16) of the guillotine (13) is positioned beneath the build material (18) which may, for example, sit on a vibration mesh or equivalent (see FIG. 2, diagram 4, mesh not shown). The first volume (21) comprising an article layer (21) may be decaked, for example automatically decaked, to remove non-solidified build material (18) from each article (20). A first volume (21), or a subsequent volume, of build material may be removed from the remaining volume (22) of build material before decaking. For example, the first volume (21) of build material may be removed from the remaining volume (22) of build material where the decaking operation comprises vibration.

In an additive manufacturing process, curing may be done to heat the powder bed with its manufactured or printed articles (20). For example, thermal curing (for instance with latex print agents) involves first evaporation of carrier liquids, and then heating to cause the latex particles in the print agent to combine together. Where the articles (20) comprise polymeric components, curing may cure the polymers to achieve high strength in the articles (20). The multi-layer build arrangement may be cured as a whole in a curing operation. Alternatively, in an example, a first volume (21) of build material (18) may be cured after the first volume (21) of build material (18) has been isolated or divided by the guillotine (13) from the remaining volume (22) of build material. This may be done, for example, as soon as the guillotine (13) has been inserted and has cut the build material (18) (for example, as shown in FIG. 2, diagram 2). Or the curing may be done at a later point, for example after the first volume (21) has been removed away from the remaining volume (22) (for example, as shown in FIG. 2, diagram 3), or, for example, only once the first volume (21) or the articles (20) within the first volume (21) have been released (for example, as shown in FIG. 2, diagrams 4 or 5 respectively). Thus, a first volume (21), or a subsequent volume, of build material (18) may be cured on its own, or in isolation, without needing to cure the whole of the multi-layer build arrangement. This allows a relatively small volume of build material (18) to be cured, and may boost the productivity and efficiency of the curing process. In this manner, the article production cost (TCO) may be significantly reduced.

The divider, for example a guillotine (13), may be operated, for example automatically, to perform a number of operations in a sequential or continuous manner. For example, the guillotine (13) may be moved to separate or isolate and then support the first volume (21) of build material, or be moved to remove the first volume (21) from the remaining volume (22) (that is, physically separate the first volume (21) at least some distance away from the remaining volume (22)), or be moved again to release the first volume (21). Releasing the first volume (21) may for example comprise positioning an aperture (16) of the guillotine (13) underneath an article layer (21), such that the layer may be decaked. During separation or removal, the first volume (21) may continue to be supported by the guillotine (13). The first volume (21) may for example be released on to a decaking area (17, 25), and the non-solidified material decaked from the articles (20). The non-solidified build material (18) may, for example, be released through an aperture (16) of the guillotine (13) (as for example illustrated in FIG. 2, diagram 4). The guillotine (13) may, for example, be returned to its original position in order to separate a further volume of build material (18) in a similar manner, thus repeating the process. The process may for example be operated continuously to remove subsequent volumes of build material, each volume having a given or chosen height.

The divider, for example a guillotine (13), may thus be moved into a number of positions, depending upon the part of the process being carried out. The first volume (21), and for example, each further volume, may comprise only one article layer (21). This may help for metallic or delicate articles because automatic decaking of the article layer (21) may be performed without damaging the articles (20). However, any build material (18) may be separated and processed in the manner described above, and more than one article layer may be separated and removed at any given point, as desired.

A method may thus for example comprise automating the method to repeat so as to remove a further volume of build material (18) from the remaining volume (22) of build material (18) in the multi-layer build arrangement.

Before any separation, the build material (18) or powder bed in the build chamber (11) comprising a plurality of articles (20) manufactured by the additive manufacturing system may be cooled before or after curing, or both before and after curing. This may for example be unassisted cooling or accelerated cooling. Cooling may take many hours, depending upon the nature of the build material. For example, some plastics materials may need a cooling period of about 20 hours. Alternatively, a first volume (21) of build material (18) or a remaining volume (22) of build material (18) may be cooled after separation by a divider (13) has taken place. Separation of the first volume (21) of build material (18) by a guillotine (13) from the remaining volume (22) of build material (18) may for example be performed when the temperature of the build material (18) is less than about 80° C. For example, the temperature of the build material (18) may be about 60° C. or more, or about than 70° C. or more, when the guillotine (13) in inserted. This may speed up the processing time, for example for plastics or delicate articles.

In another example, an additive manufacturing system (10) comprises a controller (5) to control a build chamber (11) to present a first volume (21) of build material (18) from a multi-layer build arrangement (18) comprising a plurality of article layers, each article layer (21) comprising an article (20), the controller (5) determining when the first volume (21) of build material (18) of the multi-layer build arrangement (18) can be removed from a remaining volume (22) of build material (18) of the multi-layer build arrangement, wherein the first volume (21) comprises an article layer (21). The remaining volume (22) may also comprise an article layer (21). The above process may be carried out in the printer. Alternatively, the build chamber (11) may, for example, be removed to a powder management station—in this case, the process may be performed by an additive manufacturing post-processing system.

In an example, a divider, for example guillotine (13), may be used to separate and remove the first volume (21) of build material, although any suitable equivalent may be used. For example, a guillotine (13) may support the first volume (21) by forming the base of a container which may be placed over, and receive, the first volume (21), and the guillotine (13) and container may then be moved, for example slid sideways, in order to remove the first volume (21) from the remaining volume (22). Alternatively, a guillotine (13) may be used to separate the first volume (21), and an alternative method of removing the first volume (21) may be employed. For example, another system may be used to move or push an article layer to one side after it has been cut, for example for decaking. Such a system may comprise a suitable frame, for example a frame with a lid.

The controller (5) may comprise, for example, a programmable logic controller (5) such as a microprocessor, forming part of the processing circuitry of the additive manufacturing post-processing system (10). The controller (5) may control the general operation of the additive manufacturing post-processing system (10). As shown in FIG. 1, the controller (5) may be coupled to a memory (6) that stores machine executable instructions. The memory (6) can, for example, be a non-transitory machine-readable storage medium and may, for example, be a read only memory (6) and/or a random access memory (6). The programmable logic controller (5) may carry out the instructions stored in the memory (6).

The build chamber (11) and the guillotine (13) may for example be as described above.

A controller (5) may for example control the build chamber (11) to present a first volume (21) of build material (18) from the multi-layer build arrangement (18). The controller (5) may for example automatically indicate to the build chamber (11) when it may eject a portion of the multi-layer build arrangement from the build chamber (11)—this indication may for example be based upon data indicating when a container (12) is correctly positioned. An example of this is illustrated in FIG. 2, diagrams 1 and 2. The controller (5) may also use data which serves to indicate what height of the first volume (21) of build material (18) the build chamber (11) may present, or use data which indicates the position of each article layer within the build chamber. This data may for example be based upon the configuration of articles (20) within the build material, and may depend upon the vertical size or dimension of an article (20) within an article layer (21). Suitable ejection apparatus (24) may read the above data to determine how far to eject the build material so that a divider, for example a guillotine (13) may be inserted at a fixed point such that it will not damage any articles. Suitable ejection apparatus (24) may function to eject or present the first volume (21) (or a subsequent volume) of the build material (18) from the build chamber (11). For example, the ejection apparatus (24) may be a hydraulically operated platform (24) which may be raised or lowered within the build chamber (11). The first volume (21) of build material (18) may comprise only one article layer (21) or may comprise more than one article layer (21).

The controller (5) may serve to determine when a divider, for example a guillotine (13), may be used to divide or separate the first volume (21) of build material (18) of the multi-layer build arrangement (18) from a remaining volume (22) of build material (18) of the multi-layer build arrangement. This determination may for example be based upon when the ejection or presentation of the correct height of the first volume (21) of build material (18) has been completed. A further or additional indication may for example be when a container (12) has received the first volume (21) of build material (18) and the container (12) is securely positioned. Once the controller (5) has determined when the guillotine (13) may be used, it may further operate to instruct or control movement of the guillotine (13).

The additive manufacturing system (10) may further comprise the controller (5) detecting the presence of a container (12) to receive a first volume (21) of build material. The controller (5) may detect, for example, when a container (12) is correctly aligned with the build platform, and when the container (12) is secured, for example fastened, in position. The container (12) may for example be latched to the build platform. Upon such detection, the controller (5) may provide an instruction to cause the first volume (21) of build material (18) to be presented from the build chamber (11). The presentation of subsequent further volumes of build material may be controlled by the controller (5) in a similar manner.

Any suitable container (12) may be used to receive the first volume (21) of build material. As shown in FIG. 1, for example, a container (12) such as a buffer box may be used. This may be positioned above the build chamber (11) and the guillotine (13) as illustrated in FIG. 1. The container (12) may for example be aligned with the build chamber (11) or platform. The positioning and alignment of the container (12) may for example be carried out automatically, and may for example be controlled by a further controller (5), which may for example function to control a robotic arm or the like to position and align the container (12).

The additive manufacturing system (10) may further comprise the controller (5) controlling a divider, for example a guillotine (13), or other suitable equivalent to cut and support the first volume (21) of build material. A suitable equivalent may for example be any sheet material, for example a metal sheet or sheet material comprising another material such as ceramic or composites. A guillotine (13) may for example comprise an aperture (16) through which the first volume (21) of build material (18) may be presented. The guillotine (13) may be any suitable guillotine (13) and may, for example, comprise sheet metal of about 1.5 mm in thickness. It may comprise a hole or aperture (16), which aperture (16) may be approximately central to the guillotine (13), as for example illustrated in FIGS. 1 and 2. Alternatively, the guillotine (13) may comprise a simple blade or sheet and no aperture, the blade being inserted into the build material to slice an article layer. Where used, a guillotine (13) comprising an aperture (16) may thus define portions or ends (14) and (15) of the guillotine (13), it being understood that the guillotine (13) may be formed from a continuous sheet. The guillotine may comprise one or more than one aperture.

For example, in a starting or original position (see FIG. 1 and FIG. 2, diagram 1), the aperture (16) of the guillotine (13) may be controlled by the controller (5) to align with the build chamber (11) such that a first volume (21) of build material (18) may be presented through the aperture (16) to be received by a container (12). However, other configurations are possible. From such a position, the controller (5) may control the guillotine (13) to move so as to insert into the build material (18) between two article layers at a desired position.

In another example, the controller (5) may control a container (12) or other suitable equivalent to cut or divide the first volume (21) of build material (18). In this arrangement, the container (12) may comprise a suitable mechanism, for example a blade, suitably a metal blade, and the container may be moved or dragged across the build material (18) in order to separate a first volume (21) of build material (18) from a remaining volume (22) of build material. The blade may for example be integral to the container (12).

As indicated above, the additive manufacturing system (10) may comprise the controller (5) controlling an ejection apparatus (24) of the build chamber (11) to eject a first (or subsequent) volume of the build material. This first volume (21), and any subsequent volume, may be pre-determined, for example with respect to the height of the build material (18) ejected—for example, the height of any given article layer (21)—or with respect to the number of article layers which are to be ejected. A plurality of article layers may be ejected either all together, or one at a time, depending upon the choice of the operator and the nature of the printed articles (20) in the multi-layer build arrangement. For example, the controller (5) may receive information from the additive manufacturing system (10) or 3D printer system concerning the number and height of the article layers present in the multi-layer build arrangement (18). This information may be used by the controller (5) to control the operation of the additive manufacturing post-processing system (10), as described above.

In a further example, a non-transitory computer-readable storage medium comprises computer executable instructions which, when executed by a processor, cause an additive manufacturing system to perform a method, the method comprising presenting a first volume (21) of build material (18) from a multi-layer build arrangement comprising a plurality of article layers, each article layer (21) comprising an article (20); and determining when a guillotine (13) can be used to separate the first volume (21) of build material (18) of the multi-layer build arrangement from a remaining volume (22) of build material (18) of the multi-layer build arrangement, wherein the first volume (21) is to comprise an article layer (21).

The remaining volume (22) may also comprise an article layer (21), or the remaining volume may comprise non-solidified build material which does not comprise an article layer. This may for example be the case when all the article layers have been removed and there is some build material (comprising no articles) remaining in the build chamber (11). The remaining volume (22) may be provided to comprise a plurality of article layers. The method may further comprise determining when a guillotine (13) can be used to separate a further volume of build material (18) of the multi-layer build arrangement from a remaining volume (22) of build material (18) of the multi-layer build arrangement, wherein the further volume is to comprise an article layer (21).

The memory (6) can be a non-transitory machine-readable storage medium and may, for example, be a read only memory (6) and/or a random access memory (6). A controller (5), as described above, for example a programmable logic controller (5), may carry out the instructions stored in the memory (6). FIG. 1 shows an example of a non-transitory computer-readable storage medium (memory (6)) and an associated controller (5).

The non-transient computer readable medium may be any electronic magnetic, optical or other physical storage device that stores executable instructions, sometimes referred to as a memory (6). Thus, the non-transient computer readable medium may be, for example, Random Access Memory (RAM), and Electrically-erasable Programmable read-Only Memory (EEPROM), a storage drive, an optical disc, and the like.

In an example, a divider, for example a guillotine (13) may be used to separate and remove the first volume (21), or a further volume, of build material. For example, a guillotine (13) may support the first volume (21) by forming the base of a container (12) which may be placed over, and receive, the first volume (21), and the guillotine (13) and container (12) may then be moved, for example slid sideways, in order to remove the first volume (21) from the remaining volume (22). Alternatively, a guillotine (13) may be used to separate the first volume (21), or a further volume, and an alternative method of removing the first volume (21) may be employed.

FIG. 1 shows one example of an additive manufacturing system (10).

Build chamber (11) comprises a multi-layer build arrangement, shown generally at (18), comprising a plurality of manufactured articles (20). A guillotine (13) shown above the build chamber (11) comprises flat end portions (14, 15) and a central hole or aperture (16). The guillotine (13) may be made of any suitable material. It may, for example, be formed from sheet metal. The guillotine (13) is slideable in either direction above the build chamber (11). A container (12), for example a buffer box, may be positioned above the aperture (16) in order to receive and hold build material (18) when, in operation, it is presented or ejected from the build chamber (11). A decaking area (17, 25) to the side of the build chamber (11) may be used for decaking articles (20).

The guillotine (13) may for example be slid into or otherwise received by the container (12) so as to provide a base for the container (12) to prevent the manufactured articles (20) from falling out of the container (12) once the container (12) has received the articles (20). For example, the lower portion of the container (12) may be provided with support members (not shown) such as runners or channels to receive the guillotine (13) to form a base of the container (12).

FIG. 2 shows one example of a method of operating an additive manufacturing system in a series of diagrams 1-5. Diagram 1 shows a build chamber (11) comprising a multi-layer build arrangement, shown generally at (18), comprising a plurality of manufactured articles (20) at the beginning of the process. The system, for example by means of a controller (5) providing instructions to the system, functions so as moves a portion of the build material (18) up through the aperture (16) in the guillotine (13), as indicated by the vertical arrow.

FIG. 2, diagram 2 shows ejection apparatus (24) having moved the multi-layer build arrangement to eject a first volume (21) of build material (18) which in this example comprises only one article layer (21). Container (12) is moved down to enclose the article layer (21), and the guillotine (13) moves across in the direction of the arrow (to the left) to cut the build material (18) and to separate the article layer (21) from the remaining build volume (22). The guillotine (13) serves as a base for the article layer (21) comprising articles (20).

FIG. 2, diagram 3 shows the removal or transfer of the article layer (21) away from the remaining build volume (22) by movement of the container (12) in the direction indicated by the arrow (to the right). The guillotine (13) is also displaced, with end portion (15) of the guillotine (13) supporting the article layer (21) and the container (12).

FIG. 2, diagram 4 shows the guillotine (13) further displaced to the right so that aperture (16) in the guillotine (13) is positioned underneath the article layer (21). The articles (20) may for example be decaked. The decaking area (17, 25), shown generally by (25), may comprise a vibration mesh or similar, on which the article layer (21) is seated, and which is suitable for decaking. Alternatively, or in addition, the container (12) may be vibrated. This may be achieved, for example, by vibrating the container (12) externally or with an internal vibrator. Alternatively, or in addition, a pulsed vacuum may provide vibrations. Non-solidified build material (18) is free to fall through aperture (16) and into the decaking area (17, 25).

FIG. 2, diagram 5 shows decaked articles (20) supported by end (15) of the guillotine (13). The guillotine (13) has been returned so that aperture (16) is now re-positioned over the build chamber (11) thus leaving an opening to receive a further volume of build material (18) from the remaining volume (22) of build material. Container (12) is returned back to its original position, for example by being moved upwards and sideways as indicated by the arrow in diagram 5. The articles (20) may be removed from the decaking area (17, 25), for example to be sintered. The removal may be done by any suitable means, for example by use of a robotic arm. In an example, the articles (20) may be removed from the decaking area (17, 25), for example on to a rotary table. The rotary table may receive in a similar way articles (20) that have been processed from further article layers.

In an example, the same container (12) that received the first volume (21) may be used to receive second and subsequent volumes of build material (18) from the build chamber (11). Alternatively, in a further example, a separate or different container (12) may be used to receive each subsequent or further volume of build material, or it may be possible to employ, for example, two or three containers in rotation. This may improve the efficiency of the process.

The process may then be repeated in order to remove and decake further portions of build material (18) from the build chamber (11). Part or all of the process may be fully automated, and the process may be run in a continuous operation.

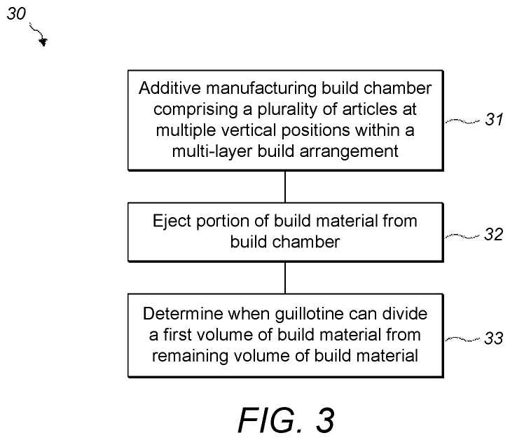

FIG. 3 shows a flow chart of an example of a method of operating an additive manufacturing system (30). An additive manufacturing system, indicated generally at 30, may be controlled to perform a method which comprises, providing an additive manufacturing build chamber comprising a plurality of articles at multiple vertical positions within a multi-layer build arrangement, as shown at 31; ejecting a portion of build material from the build a chamber, as shown at 32; and determining when a divider, for example a guillotine, can divide a first volume of build material from a remaining volume of build material. A suitable controller may be used to control the system to perform the method.

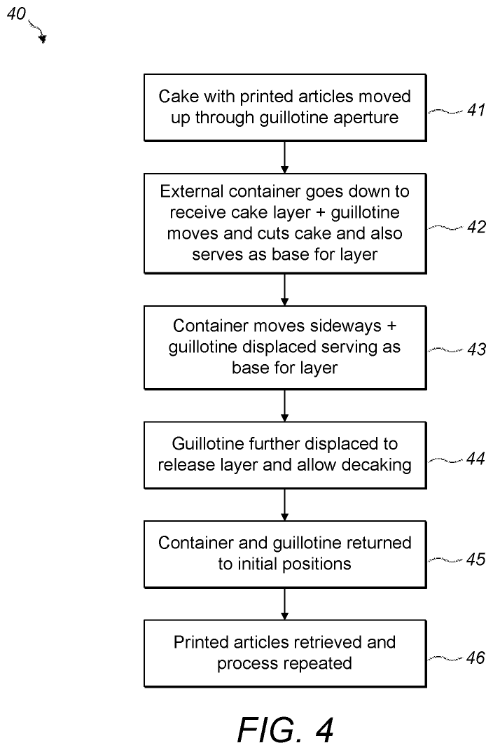

FIG. 4 shows a flow chart of an example of a method of operating an additive manufacturing system (40). An additive manufacturing system, indicated generally at 40, may be controlled to perform a method which comprises moving 3D printed articles in build material up through an aperture in a divider such as a guillotine, as shown at 41; moving an external container down to receive the build material and moving a guillotine to cut and separate a portion of the build material, as shown at 42; moving the container and guillotine sideways, the guillotine serving as a supporting base for the portion of build material, as shown at 43; displacing the guillotine further so as to release the portion of build material and allow decaking, as shown at 44; returning the container and guillotine to their initial positions, as shown at 45; and retrieving the 3D printed articles and repeating the process, as shown at 46. A suitable controller may be used to control the system to perform the method.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. An apparatus comprising a controller to cause an additive manufacturing system to perform a method, the method comprising:
controlling the additive manufacturing system to provide a plurality of articles in a multi-layer build arrangement in a build chamber, the multi-layer build arrangement comprising a plurality of article layers, each article layer comprising an article;
ejecting a portion of the multi-layer build arrangement from the build chamber; and
determining when a divider can be used to divide a first volume of build material of the multi-layer build arrangement from a remaining volume of build material of the multi-layer build arrangement, wherein the first volume comprises an article layer.

2. An apparatus according to claim 1, wherein the method further comprises inserting the divider into the build material to separate the first volume from the remaining volume.

3. An apparatus according to claim 1, wherein the first volume comprises only one article layer.

4. An apparatus according to claim 1 wherein the articles comprise a metallic material.

5. An apparatus according to claim 2 wherein to effect insertion of the divider, a tensile force is applied to the divider.

6. An apparatus according to claim 1, the method further comprising decaking an article from the first volume.

7. An apparatus according to claim 1, the method further comprising curing the first volume of build material after the first volume of build material has been isolated by the divider.

8. An apparatus according to claim 2, the method further comprising automatically moving the divider to isolate and support the first volume, remove the first volume from the remaining volume, and release the first volume.

9. An apparatus according to claim 1, the method further comprising automating the method to repeat so as to remove a further volume from the remaining volume.

10. An apparatus according to claim 2, wherein separation of the first volume is performed when the temperature of the build material is 70° C. or more.

11. An additive manufacturing system comprising:
a controller to control a build chamber to present a first volume of build material from a multi-layer build arrangement comprising a plurality of article layers, each article layer comprising an article, the controller to determine when the first volume of build material of the multi-layer build arrangement can be removed from a remaining volume of build material of the multi-layer build arrangement, wherein the first volume comprises an article layer.

12. An additive manufacturing system according to claim 11, further comprising the controller to detect the presence of a container to receive the first volume of build material.

13. An additive manufacturing system according to claim 12, further comprising the controller to control a divider to cut and support the first volume of build material.

14. An additive manufacturing system according to claim 12, further comprising the controller to control an ejection apparatus of the build chamber to eject a pre-determined number of article layers.

15. A non-transitory computer-readable storage medium comprising computer executable instructions which, when executed by a processor, cause an additive manufacturing system to perform a method, the method comprising:
presenting a first volume of build material from a multi-layer build arrangement comprising a plurality of article layers, each article layer to comprise a 3D printed article; and
determining when a divider can be used to separate the first volume of build material of the multi-layer build arrangement from a remaining volume of build material of the multi-layer build arrangement, wherein the first volume is to comprise an article layer.
